(19) United States
(12) Patent Application Publication
(10) Pub. No.: US 2024/0329403 A1
(43) Pub. Date: Oct. 3, 2024

(54) DISPLAY DEVICE AND ELECTRONIC APPARATUS

(71) Applicant: SEIKO EPSON CORPORATION, Tokyo (JP)

(72) Inventor: Jun IROBE, SUWA-SHI (JP)

(73) Assignee: SEIKO EPSON CORPORATION, Tokyo (JP)

(21) Appl. No.: 18/619,179

(22) Filed: Mar. 28, 2024

(30) Foreign Application Priority Data
Mar. 29, 2023 (JP) 2023-053298

(51) Int. Cl. G02B 27/01; G09G 3/3233

(52) U.S. Cl. CPC G02B 27/0172; G09G 3/3233; G02B 2027/0112; G02B 2027/0178; G09G 2300/0842

(57) ABSTRACT

A display device includes a display panel that emits color image light, and a light guiding unit that guides the color image light. When the color image light emitted from the display panel is white image light, color coordinates of the white image light are different from color coordinates of image light obtained as a result of the white image light being guided by the light guiding unit. Specifically, when the display panel emits the color image light by additive color mixing of red, green, and blue, and display unevenness in the display panel is caused by red, in the light guiding unit, the spectral transmittance of cyan, which is a complementary color of red, is adjusted to be smaller than the spectral transmittance of red.

The present application is based on, and claims priority from JP Application Serial Number 2023-053298, filed Mar. 29, 2023, the disclosure of which is hereby incorporated by reference herein in its entirety.

### BACKGROUND

### 1. Technical Field

The disclosure relates to a display device and an electronic apparatus.

### 2. Related Art

In an electro-optical device including a light-emitting element such as an organic electroluminescent (EL) element, one color pixel is constituted by, for example, RGB sub-pixels for color display. Further, a configuration is known in which a color filter that transmits light in a desired wavelength region is provided on an observation side with respect to the light-emitting element. With respect to an electro-optical device including such color pixels, a technique is known that suppresses variation in color changes due to a visual field angle (observation angle) (see JP-A-2019-117941, for example).

Specifically, the shape of each sub-pixel is identical to each other, the distance between the sub-pixels adjacent to each other is equal to each other, and a contact position of the sub-pixel is arranged at an intersection between boundary lines dividing a light-emitting region. As a result, the intervals between the light-emitting regions become equal in all the sub-pixels, and thus, when observed from an inclined direction, an angle at which light emitted from the sub-pixel reaches an adjacent color filter becomes equal in all the sub-pixels. Thus, the variation in color changes among the sub-pixels is suppressed.

However, in actuality, light distribution characteristics, that is, characteristics of changes in radiance with respect to the visual field angle become different among the sub-pixels. Specifically, since the emission spectrum is different for each color, or the optical path length in the optical resonance structure is different for each color, a difference arises in the light distribution characteristics in each of the sub-pixels. Thus, even when the technique disclosed in JP-A-2019-117941 is employed, there has been a problem in that a difference in the light distribution characteristics arises in each of the sub-pixels, and thus, color changes (color unevenness) occur due to the visual field angle.

### SUMMARY

In order to solve the problem described above, a display device according to an aspect of the disclosure includes a display panel configured to emit color image light, and a light guiding unit configured to guide the color image light. When the color image light emitted from the display panel is white image light, color coordinates of the white image light are different from color coordinates of image light obtained by the white image light being guided by the light guiding unit.

### BRIEF DESCRIPTION OF THE DRAWINGS

FIG. 1 is a diagram illustrating an optical path of a display device according to a first embodiment.

FIG. 2 is a perspective view illustrating a display panel applied to the display device.

FIG. 3 is a block diagram illustrating an electrical configuration of the display panel.

FIG. 4 is a diagram illustrating a configuration of a pixel circuit in the display panel.

FIG. 5 is a diagram for describing an operation of the display panel.

FIG. 6 is a diagram for describing white coordinates of the display device according to a comparative example.

FIG. 7 is a diagram showing the spectral transmittance and the like of a light guiding unit in the comparative example.

FIG. 8 is a diagram for describing white coordinates and the like of the display device according to Countermeasure 1 of the embodiment.

FIG. 9 is a diagram showing change characteristics of a color difference with respect to an observation angle of the display device.

FIG. 10 is a diagram showing change characteristics of xyz components with respect to the observation angle of the display device.

FIG. 11 is a diagram showing change characteristics of RGB components with respect to the observation angle of the display device.

FIG. 12 is a diagram showing the change characteristics of the RGB components with respect to the observation angle, when the R component is weakened.

FIG. 13 is a diagram showing the change characteristics of the x component with respect to the observation angle.

FIG. 14 is a diagram showing the change characteristics of the color difference with respect to the observation angle.

FIG. 15 is a diagram for describing the white coordinates of the display device according to Countermeasure 1 of the embodiment.

FIG. 16 is a diagram showing causes of color unevenness and countermeasures against the causes in a patterned manner.

FIG. 17 is a diagram showing the change characteristics of the y component with respect to the observation angle when the G component is weakened.

FIG. 18 is a diagram showing the change characteristics of the color difference with respect to the observation angle.

FIG. 19 is a diagram for describing the white coordinates and the like of the display device according to Countermeasure 2 of the embodiment.

FIG. 20 is a diagram for describing the white coordinates of the display device according to Countermeasure 2 of the embodiment.

FIG. 21 is a diagram showing the change characteristics of the z component with respect to the observation angle when the B component is weakened.

FIG. 22 is a diagram showing the change characteristics of the color difference with respect to the observation angle.

FIG. 23 is a diagram for describing white coordinates of the display device according to Countermeasure 3 of the embodiment.

FIG. 24 is a diagram for describing the white coordinates of the display device according to Countermeasure 3 of the embodiment.

FIG. 25 is a diagram illustrating a headset applied to the display device.

FIG. 26 is a diagram illustrating an optical configuration of the headset.

FIG. 27 is a diagram illustrating the optical path of the display device according to a first modified example of the embodiment.

FIG. 28 is a diagram illustrating the optical path of the display device according to a second modified example of the embodiment.

### DESCRIPTION OF EMBODIMENTS

Hereinafter, an embodiment of the disclosure will be described with reference to the drawings. Note that in each of the drawings, dimensions and scale of each part are made different from actual ones as appropriate. Moreover, the embodiment described below is a suitable specific example, and various technically preferable limitations are applied, but the scope of the disclosure is not limited to these modes unless they are specifically described in the following description as limiting the disclosure.

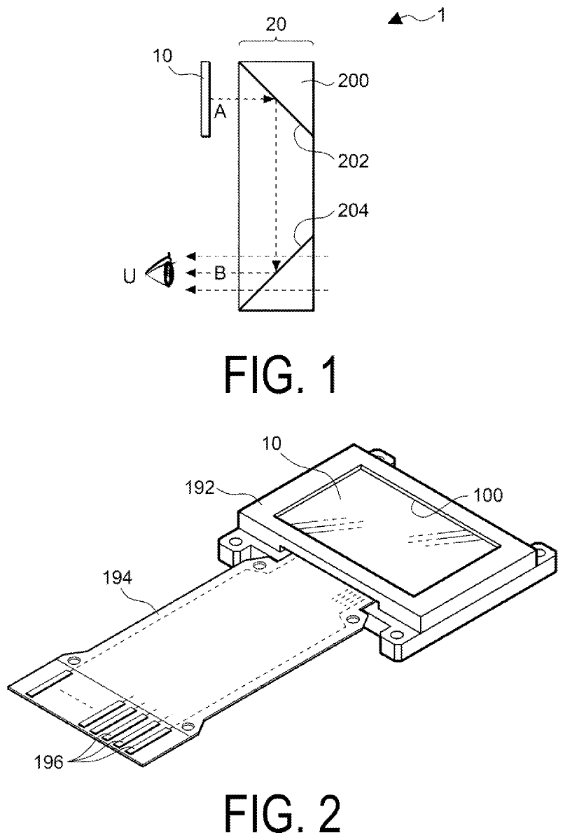

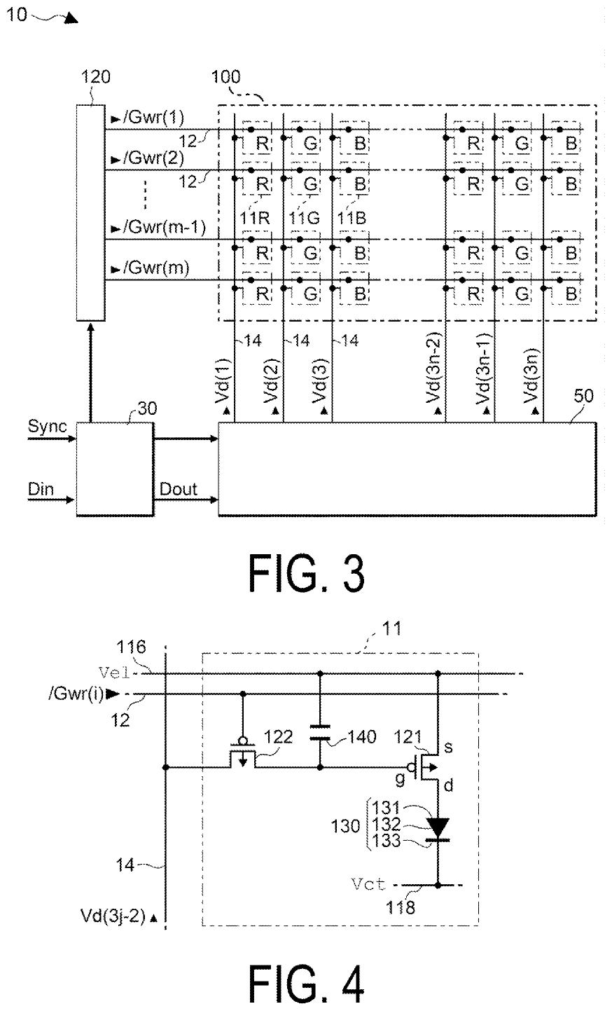

FIG. 1 is a diagram illustrating a configuration of a display device 1 according to the embodiment, FIG. 2 is a perspective view illustrating an external appearance of a display panel 10 applied to the display device 1, and FIG. 3 is a diagram illustrating an electrical configuration of the display panel 10.

The display device 1 is applied to such a headset as described later. As illustrated in FIG. 1, the display device 1 includes the display panel 10 and a light guiding unit 20. The display panel 10 is a micro display panel that generates image light. The display panel 10 includes a plurality of sub-pixels, a drive circuit that drives the sub-pixels, and the like. The sub-pixels and the drive circuit are integrated into a semiconductor substrate. The semiconductor substrate is typically a silicon substrate, but may be a different semiconductor substrate.

The emission direction of the image light from the display panel 10 is a three o'clock direction in FIG. 1. The light guiding unit 20 includes an optical path unit 200, a mirror 202, and a half mirror 204. The mirror 202 reflects the image light emitted from the display panel 10 in a six o'clock direction in FIG. 1 The half mirror 204 reflects the image light reflected by the mirror 202 in a nine o'clock direction in FIG. 1, while transmitting outside light entering from the three o'clock direction.

With this configuration, a user U positioned in the nine o'clock direction with respect to the light guiding unit 20 visually recognizes the image light from the display panel 10 in a see-through state in which the image light is superimposed on an outside scene.

Note that a point at which the image light is observed after being emitted from the display panel 10 and before entering the light guiding unit 20 is referred to as an observation point A. Further, a point at which the image light, which is emitted from the light guiding unit 20 and visually recognized by the user U, is observed is referred to as an observation point B.

As illustrated in FIG. 2, the display panel 10 is accommodated in a frame-shaped case 192 having an opening provided in a display unit 100. The display panel 10 is coupled to one end of an FPC board 194. Note that FPC is an abbreviation for flexible printed circuit. The other end of the FCP board is coupled to a host device (not illustrated). Note that the image light is emitted from the display panel 10 in the upward direction in FIG. 2.

FIG. 3 is a diagram illustrating an electrical configuration of the display panel 10. The display panel 10 is roughly divided into a control circuit 30, a data signal output circuit 50, the display unit 100, and a scanning line drive circuit 120.

In the display unit 100, scanning lines 12 of m rows are provided along the horizontal direction, and data lines 14 of (3n) columns are provided along the vertical direction so as to be electrically insulated from each of the scanning lines 12. Each of m and n is an integer equal to or greater than 2.

In order to distinguish the rows from each other in the scanning lines 12, the rows may be referred to as first, second, . . . (m-1)-th, and m-th rows in order from the top in FIG. 3. Note that, in order to generally describe the scanning line 12 without specifying the row, the scanning line 12 may be referred to as the scanning line 12 of an i-th row using an integer i of 1 or more and m or less.

Further, in order to distinguish the columns from each other in the data lines 14, the columns may be referred to as first, second, third, . . . , (3n-2)-th, (3n-1)-th, and (3n)-th columns in order from the left in FIG. 3. The data lines 14 are grouped in groups of three columns each. Here, when an integer j of 1 or more and n or less is used to generalize and describe the group of the data lines 14, the data lines 14 of (3j-2)-th, (3j-1)-th, and (3j)-th columns belong to a j-th group, as counting from the left.

Sub-pixels 11R, 11G, and 11B are provided corresponding to the scanning lines 12 arrayed in the m rows and the data lines 14 arrayed in the (3n) columns. Specifically, the sub-pixel 11R is provided corresponding to an intersection between the scanning line 12 of the i-th row and the data line 14 of the (3j-2)-th column. The sub-pixel 11G is provided corresponding to an intersection between the scanning line 12 of the i-th row and the data line 14 of the (3j-1)-th column. The sub-pixel 11B is provided corresponding to an intersection between the scanning line 12 of the i-th row and the data line 14 of the (3j)-th column.

The sub-pixel 11R emits light of a red component, the sub-pixel 11G emits light of a green component, and the sub-pixel 11B emits light of a blue component. One color pixel is expressed by additive color mixing of the light emitted from the sub-pixels 11R, 11B, and 11G. Note that the sub-pixels 11R, 11G, and 11B have the same electrical configuration. Therefore, when it is not necessary to particularly distinguish the sub-pixels from each other, the sub-pixels will be described below as the sub-pixels 11.

A synchronization signal Sync and video data Din are supplied to the display panel 10 from the host device. The synchronization signal Sync includes a vertical synchronization signal that instructs a start of vertical scanning of the video data Din, a horizontal synchronization signal that instructs a start of horizontal scanning, and a dot clock signal that indicates a timing for one pixel of the video data. The video data Din designates, for example, a gradation level of the sub-pixel to be displayed by 8 bits, for each of red, green, and blue.

The control circuit 30 controls each component based on the synchronization signal Sync. Specifically, the control circuit 30 generates various control signals to control each component, and outputs the video data Din as video data Dout in accordance with the control signals.

Note that, in the embodiment, a pixel to be displayed corresponds to the one color pixel expressed by the three sub-pixels in the display unit 100, in a one-to-one manner.

The scanning line drive circuit 120 is a circuit for driving, one row at a time, the sub-pixels 11 arrayed in m rows and (3n) columns in accordance with the control by the control circuit 30. For example, the scanning line drive circuit 120 supplies scanning signals /Gwr(1), /Gwr(2) . . . /Gwr(m-1), /Gwr(m) to the scanning lines 12 in the first, second, third . . . (m-1)-th, and m-th rows in order. To generalize, the scanning signal supplied to the scanning line 12 of the i-th row is denoted as/Gwr(i).

The data signal output circuit 50 is a circuit that outputs, via the data line 14, a data signal to the sub-pixel 11 located in a row selected by the scanning line drive circuit 120 in accordance with the control by the control circuit 30. The data signal is a signal obtained by converting the video data Dout into an analog format for each of RGB. In other words, the data signal output circuit 50 converts, into the analog format, the video data Dout of one row corresponding to the sub-pixels 11 of the first to (3n)-th columns in the selected row, and outputs the analog data to the data lines 14 of the first to (3n)-th columns in order.

In the drawing, the data signals output to the data lines 14 of the first, second, third, . . . , (3n-2)-th, (3n-1)-th, and (3n)-th columns are referred to as Vd(1), Vd(2), Vd(3), . . . , Vd(3n-2), Vd(3n-1), and Vd(3n). To generalize, the data signal supplied to the data line 14 of a j-th column is denoted as Vd(j).

FIG. 4 is a diagram illustrating an electrical configuration of the sub-pixel 11. As illustrated in FIG. 4, the sub-pixel 11 includes P-channel MOS type transistors 121 and 122, an OLED 130, and a capacitive element 140 from the electrical point of view.

The OLED 130 is an example of a light-emitting element in which a light-emitting layer 132 is sandwiched between a pixel electrode 131 and a common electrode 133. The pixel electrode 131 serves as an anode, and the common electrode 133 serves as a cathode. In the OLED 130, when a current flows from the anode to the cathode, holes injected from the anode and electrons injected from the cathode recombine in the light-emitting layer 132 to generate excitons, and white (achromatic color) light is generated.

For example, the generated white light resonates in an optical resonator constituted by a reflective electrode and a semi-reflective and semi-transmissive layer (not illustrated). In the case of the sub-pixel 11R, the light is emitted at a resonance wavelength set corresponding to red. In this case, a colored layer (color filter) corresponding to red is provided on a side from which the optical resonator emits the light. Therefore, the emitted light from the OLED 130 is visually recognized by the user U via the optical resonator and the colored layer.

Note that, in the case of the sub-pixel 11G, the light is emitted at a resonance wavelength set corresponding to green and is visually recognized by the user U via a colored layer corresponding to green, and in the case of the sub-pixel 11B, the light is emitted at a resonance wavelength set corresponding to blue and is visually recognized by the user U via the colored layer corresponding to blue.

For example, in the transistor 121 of the sub-pixel 11 of the i-th row and the (3j-2)-th column, a gate node g is coupled to a drain node of the transistor 122, a source node is coupled to a power supplying line 116 of a voltage Vel, and the drain node is coupled to the pixel electrode 131, which is an anode of the OLED 130.

In the transistor 122 of the sub-pixel 11 of the i-th row and the (3j-2)-th column, a gate node is coupled to the scanning line 12 of the i-th row, and a source node is coupled to the data line 14 of the (3j-2)-th column. The common electrode 133, which functions as a cathode of the OLED 130, is coupled to a power supplying line 118 of a voltage Vct.

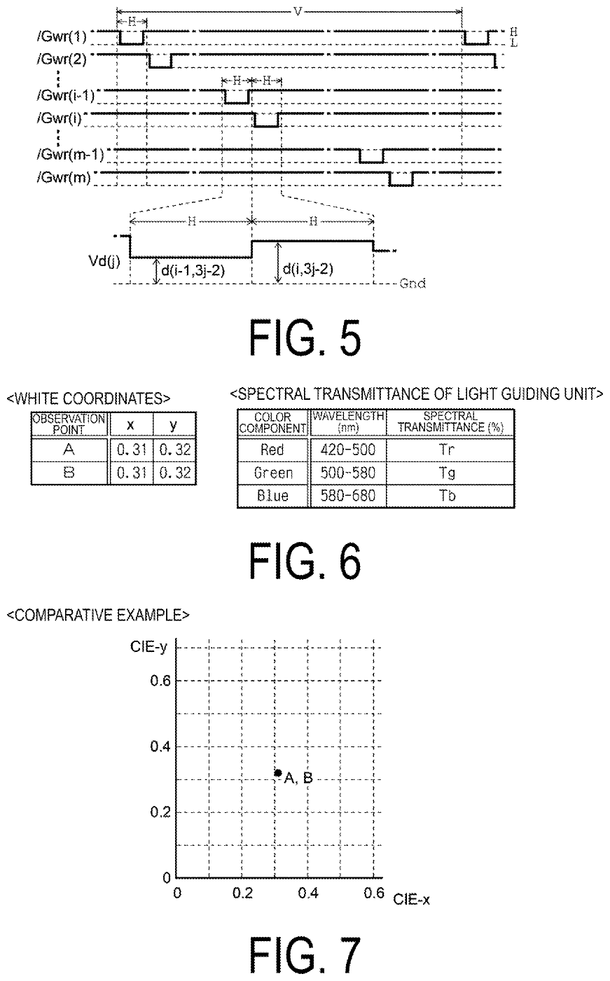

FIG. 5 is a timing chart for describing an operation of the display panel 10.

In the display panel 10, the scanning lines 12 of m rows are scanned one by one in order of the first, second, third . . . , m-th rows during a period of a frame (V). Specifically, as illustrated in FIG. 5, the scanning signals /Gwr(1), /Gwr(2) . . . /Gwr(m-1), and/Gwr(m) successively and exclusively reach an L level for each horizontal scanning period (H) by the scanning line drive circuit 120.

Note that, in the embodiment, a period during which the adjacent scanning signals among the scanning signals /Gwr(1) to/Gwr (m) reach the L level is temporally isolated. Specifically, after the scanning signal /Gwr(i-1) changes from the L level to a H level, the next scanning signal /Gwr(i) reaches the L level after a period of time. This period corresponds to a horizontal return period.

In this description, the period of one frame (V) refers to a period required to display one frame of an image designated by the video data Vid. In a case in which a length of the period of one frame (V) is the same as a vertical synchronization period, for example, when a frequency of a vertical synchronization signal included in the synchronization signal Sync is 60 Hz, it is 16.7 milliseconds, which corresponds to one cycle of the vertical synchronization signal. Further, the horizontal scanning period (H) is an interval of time in which the scanning signals /Gwr(1) to/Gwr(m) reach the L level in order, but in the drawing, for convenience, a start timing of the horizontal scanning period (H) is approximately a center of the horizontal return period.

When a certain scanning signal among the scanning signals /Gwr(1) to/Gwr(m), for example, the scanning signal /Gwr (i) supplied to the scanning line 12 of the i-th row reaches the L level, speaking of the (3j-2)-th column, the transistor 122 in the sub-pixel 11 of the i-th row and the (3j-2)-th column obtains an ON state. Thus, the gate node g of the transistor 121 in the sub-pixel 11 is electrically coupled to the data line 14 of the (3j-2)-th column.

Note that, in this description, the “ON state” of the transistor or a switch means that a distance between the source node and the drain node in the transistor or between both ends of the switch is electrically closed to be in a low impedance state. Further, an “OFF state” of the transistor or the switch means that the distance between the source node and the drain node or between both ends of the switch electrically opens to be in a high impedance state.

Further, in this description, “electrically coupled” or simply “coupled” means a state in which two or more elements are directly or indirectly coupled or joined. “Electrically non-coupled” or simply “non-coupled” means a state in which two or more elements are not directly or indirectly coupled or joined.

In the horizontal scanning period (H) in which the scanning signal /Gwr(i) reaches the L level, the data signal output circuit 50 converts R values, G values, and B values respectively corresponding to the sub-pixels of the i-th row and the first column to the i-th row and the (3n)-th column indicated by the video data Dout, into analog data signals Vd(1) to Vd(n), and outputs the analog data signals Vd(1) to Vd(n) to the data signals 14 in the first to (3n)-th columns. Speaking of the (3j-2)-th column, the data signal output circuit 50 converts d (i, 3j-2) of the R value corresponding to the sub-pixel 11R of the i-th row and the (3j-2)-th column into the analog data signal Vd(j), and outputs the analog data signal Vd(j) to the data line 14 of the (3j-2)-th column.

Note that, in the horizontal scanning period (H) in which the scanning signal /Gwr(i-1) one line before the scanning signal /Gwr(i) reaches the L level, the data signal output circuit 50 converts d (i-1, 3j-2) of the R value of the sub-pixel 11R of the (i-1)-th row and the (3j-2)-th column into the analog data signal Vd(3j-2), and outputs the analog data signal Vd(3j-2) to the data signal 14 of the (3j-2)-th column.

The data signal Vd(3j-2) is applied to the gate node g of the transistor 121 in the sub-pixel 11 of the i-th row and the (3j-2)-th column via the data line 14 of the (3j-2)-th column, and the data signal Vd(3j-2) is retained by the capacitive element 140. Therefore, the transistor 121 causes a current corresponding to a voltage between the gate node and the source node to flow to the OLED 130.

Even when the scanning signal Gwr(i) reaches the H level and the transistor 122 obtains the OFF state, the voltage of the data signal Vd(3j-2) is retained by the capacitive element 140, and thus the current continues to flow in the OLED 130. Therefore, in the sub-pixel 11 of the i-th row and the (3j-2)-th column, the OLED 130 continues to emit light with the voltage retained by the capacitive element 140, that is, with a brightness corresponding to the gradation level, until the period of one frame (V) elapses, the transistor 122 is turned on again, and the voltage of the data signal is applied again.

Note that, although the sub-pixel 11 of the i-th row and the (3j-2)-th column has been described here, the OLEDs 130 of the sub-pixels 11 in columns other than the (3j-2)-th column in the i-th row also emit light at the radiance indicated by the video data Dout.

Further, each of the OLEDs 130 of the sub-pixels 11 other than the one of the i-th row also emits light with the radiance indicated by the video data Dout as a result of the scanning signals /Gwr(1) to/Gwr(m) reaching the L level in order.

Thus, in the display panel 10, during the period of one frame (V), each of the OLEDs 130 in all the sub-pixels 11 from the first row and the first column to the m-th row and the (3n)-th column emits light at the radiance indicated by the video data Dout, and an image of one frame is displayed.

As described above, the OLED 130 itself emits the white light, and through the optical resonator and coloring by the colored layer, the sub-pixel 11R emits the red light, the sub-pixel 11G emits the green light, and the sub-pixel 11B emits the blue light. Then, each of the light is visually recognized by the user U.

In a comparative example, which is a known technique, the display panel 10 and the light guiding unit 20 are designed such that the color coordinates of the white point at the observation point A and the color coordinates of the white point at the observation point B are not different from each other. Specifically, the display panel 10 and the light guiding unit 20 are designed such that the color coordinates (x, y) of the white point at the observation point A and the color coordinates (x, y) of the white point at the observation point B are both (0.31, 0.32) in the color coordinates of the CIE chromaticity diagram, as shown in the left table of FIG. 6 and FIG. 7.

Note that, in the comparative example (and the embodiment), as shown in the right table of FIG. 6, in the display panel 10, the wavelength of the red component emitted from the sub-pixel 11R is 420 to 500 nm, the wavelength of the green component emitted from the sub-pixel 11G is 500 to 580 nm, and the wavelength of the blue component emitted from the sub-pixel 11B is 580 to 680 nm.

Further, in the spectral transmittance of the light guiding unit 20 of the comparative example designed as described above, it is assumed that the transmittance of the red component is Tr, the transmittance of the green component is Tg, and the transmittance of the blue component is Tb.

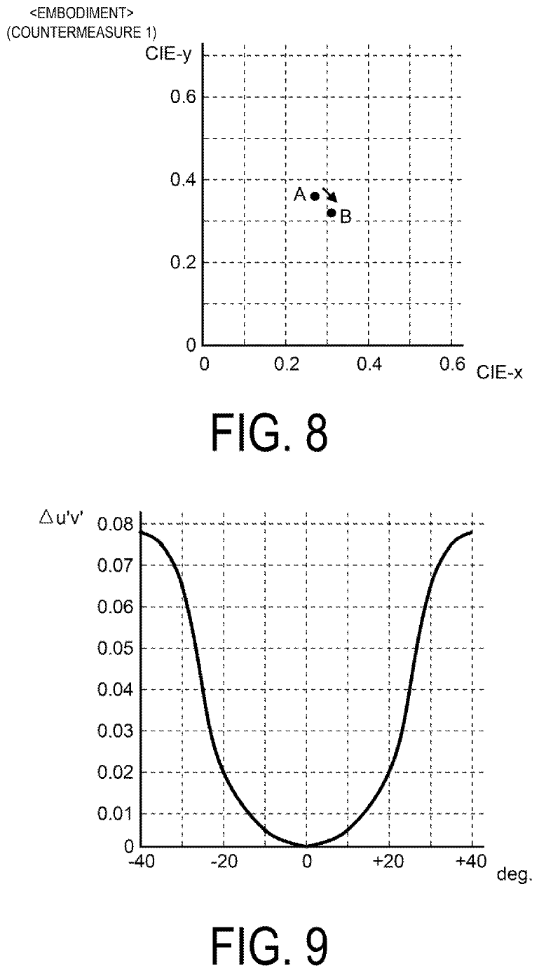

In the embodiment, as shown in FIG. 8, the white point of the display panel 10 and the spectral transmittance of the light guiding unit 20 are designed such that the color coordinates of the white point at the observation point A and the color coordinates of the white point at the observation point B are different from each other. This design will be described below in detail.

FIG. 9 shows an example of light distribution characteristics when the display panel 10 emits white light. In FIG. 9, the horizontal axis represents an observation angle when a direction perpendicular to the display panel 10 is set to an angle θ, and the vertical axis represents Au′v′. Au′v′ indicates a distance between two sets of color coordinates in a UV chromaticity diagram when two colors are compared. One of the two colors in this description is a color observed when the observation angle is 0, and the other is a color observed when the observation angle is changed. The distance Au′v′ is also referred to as a color change amount or a color difference. The distance Au′v′ is greater than 0.02, it is said that a human can perceive the color difference. In other words, when two colors are compared, if the distance Au′v′ is equal to or less than 0.02, the color difference between the two colors cannot be perceived by a human.

In the light distribution characteristics shown in FIG. 9, Δu′v′ increases as the observation angle increases from 0 degrees.

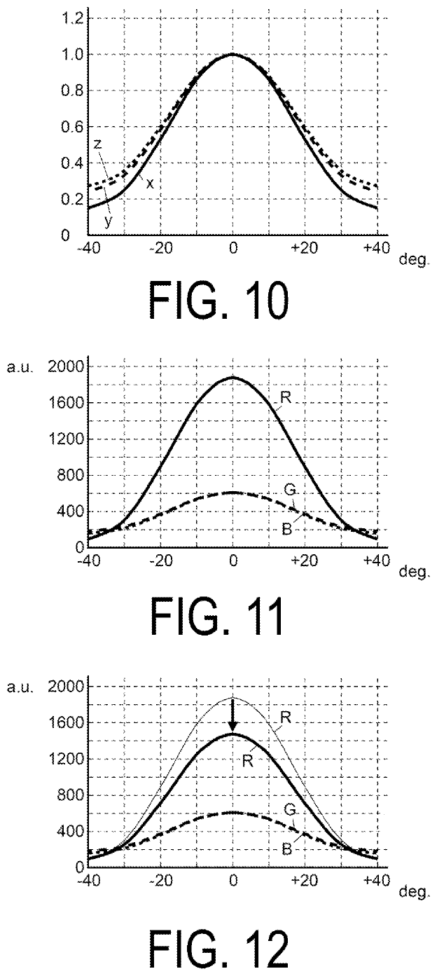

FIG. 10 is a diagram showing a cause of the color change in the light distribution characteristics described above, separately for an x component, a y component, and a z component in the XYZ color system. In FIG. 10, the horizontal axis represents the observation angle, the vertical axis represents the relative intensity of light, and the intensity when the observation angle is 0 degrees is normalized as “1”.

As shown in FIG. 10, the light distribution characteristics of the x component may be weaker than those of the y component and the z component. In other words, the x component attenuates more than the y component and the z component with respect to the change in the observation angle. In this case, the main cause of the color change is considered to be that the light distribution characteristics of the x component are weaker than those of the y component and the z component.

FIG. 11 is a diagram showing the x component broken down into the intensities of the R component, the G component, and the B component. Note that the vertical axis is an arbitrary unit indicating the intensity.

The x-component of the white light is the sum of the intensities from the sub-pixels 11R, 11G, and 11B. Thus, in FIG. 11, it can be said that the light distribution characteristics of the sub-pixel 11R having the highest intensity but having poor light distribution characteristics are dominant in the light distribution characteristics of the x-component of the white light.

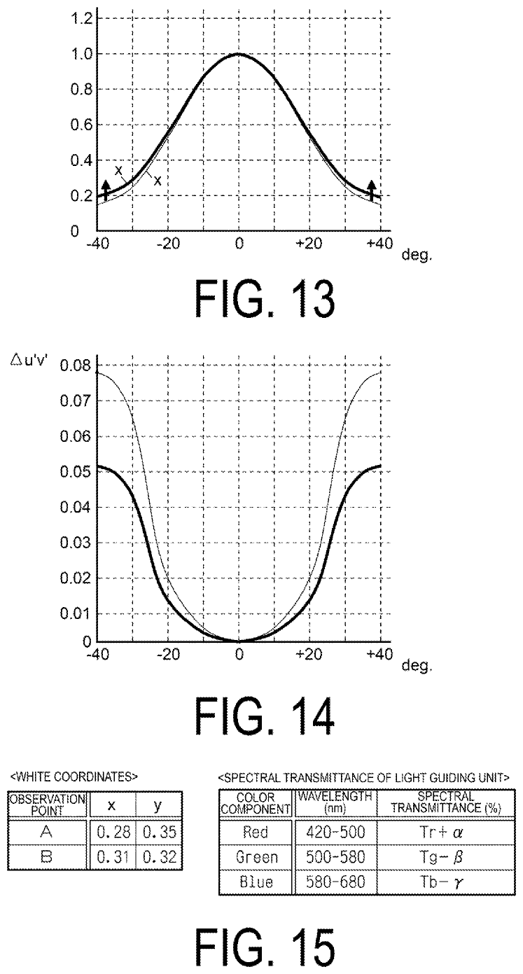

Therefore, by decreasing the intensity of the sub-pixel 11R from the thin solid line to the thick solid line as indicated in FIG. 12 in order to adjust the influence of the sub-pixel 11R to be smaller, the light distribution characteristics of the x-component of the white light are improved from the thin solid line to the thick solid line as indicated in FIG. 13. As a result, the color change of the white light is suppressed from the thin solid line to the thick solid line as indicated in FIG. 14. This is the first point of the embodiment.

However, if the intensity of the sub-pixel is adjusted in the display panel 10 in order to improve the light distribution characteristics, white coordinates are shifted. Thus, the shifted coordinates are readjusted by the spectral transmittance of the light guiding unit 20. This readjustment is the second point of the embodiment. Note that the light guiding unit 20 is a combination of a plurality of optical elements. Therefore, the total transmittance of all the optical elements constituting the light guiding unit 20 is set as the spectral transmittance of the light guiding unit 20.

For example, when the intensity of the sub-pixel 11R is decreased as described above, the white coordinates are shifted in a direction toward cyan, which is a complementary color of R. Specifically, as shown in the left table of FIG. 15 or in FIG. 8, the color coordinates (x, y) of the white point at the observation point A become (0.28, 0.35) and are shifted from the original color coordinates (0.31, 0.32) of the white point.

Note that the complementary color is a color that is located directly opposite to a certain color in the hue circle. For example, the complementary color with respect to R is cyan, the complementary color with respect to G is magenta, and the complementary color with respect to B is yellow.

In the embodiment, the spectral transmittance of the light guiding unit 20 is adjusted such that the R wavelength component becomes stronger, or the G wavelength component and the B wavelength component become weaker. Specifically, as shown in the right table of FIG. 15, the spectral transmittance of the light guiding unit 20 is adjusted such that the transmittance of the red component is strengthened by a from Tr to (Tr+α), the transmittance of the green component is weakened by β from Tg to (Tg−β), and the transmittance of the blue component is weakened by γ from Tb to (Tb−γ).

Note that all of α, β, and γ are positive values, and each of the values is determined by all the optical elements constituting the light guiding unit 20.

By such an adjustment, as shown in FIG. 8, the color coordinates of the white point at the observation point B can be returned to the original white color from the state of being biased toward cyan.

By doing so, in the embodiment, it is possible to suppress the display color shift (color unevenness) while maintaining the white color perceived by the user U.

Note that, when the color difference between the color observed at the observation point A or the color observed at the observation point B, and the white color of the color coordinates (0.31, 0.32) is 0.02 or less, the user U cannot perceive the difference between the two colors, and thus, the adjustment of the white color in the display panel 10 and/or the adjustment of the spectral transmittance of the light guiding unit 20 is not necessary. Further, when the color difference between the color observed at the observation point A and the color observed at the observation point B is 0.02 or less, similarly, the adjustment of the white color in the display panel 10 and/or the adjustment of the spectral transmittance of the light guiding unit 20 is not necessary.

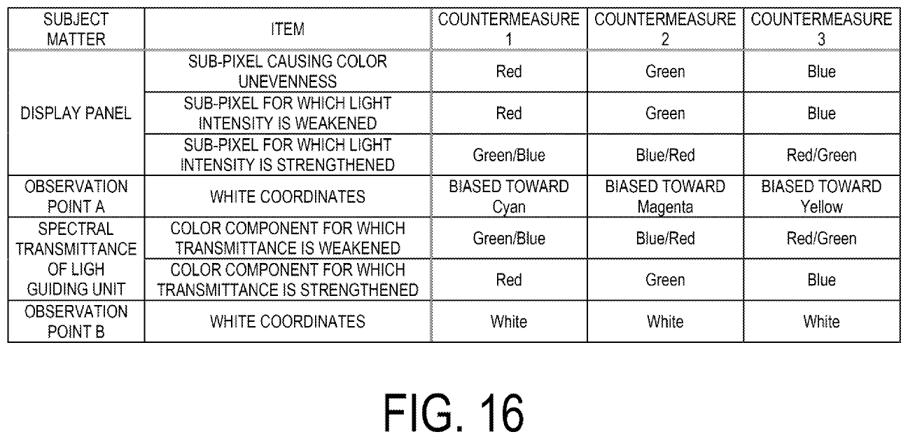

FIG. 16 is a diagram showing causes of the color unevenness and countermeasures against the causes in a patterned manner.

First, a case in which the light distribution characteristics of the sub-pixel 11R are poor in the display panel 10 as in the embodiment will be described. In this case, as described under Countermeasure 1 in FIG. 16, adjustment is performed such that the light emission intensity in the sub-pixel 11R becomes weaker (see FIG. 12) and/or the light emission intensities in the sub-pixels 11G and 11B become stronger. With such an adjustment, the light distribution characteristics of the x component of the white light is improved from the thin solid line to the thick solid line as indicated in FIG. 13, and the color change of the white light is suppressed from the thin solid line to the thick solid line as indicated in FIG. 14.

However, the white coordinates at the observation point A become biased toward cyan, as shown in the left table of FIG. 15 or in FIG. 8. In other words, display unevenness of the display panel 10 is cyan. Thus, the spectral transmittance of the light guiding unit 20 is adjusted such that the wavelength components of G and B become weaker and/or the wavelength component of R becomes stronger. With this adjustment, the white coordinates at the observation point B are returned to the white color from the state of being biased toward cyan (see FIG. 8).

As a result, the display unevenness of being biased toward cyan in the display panel 10 is suppressed.

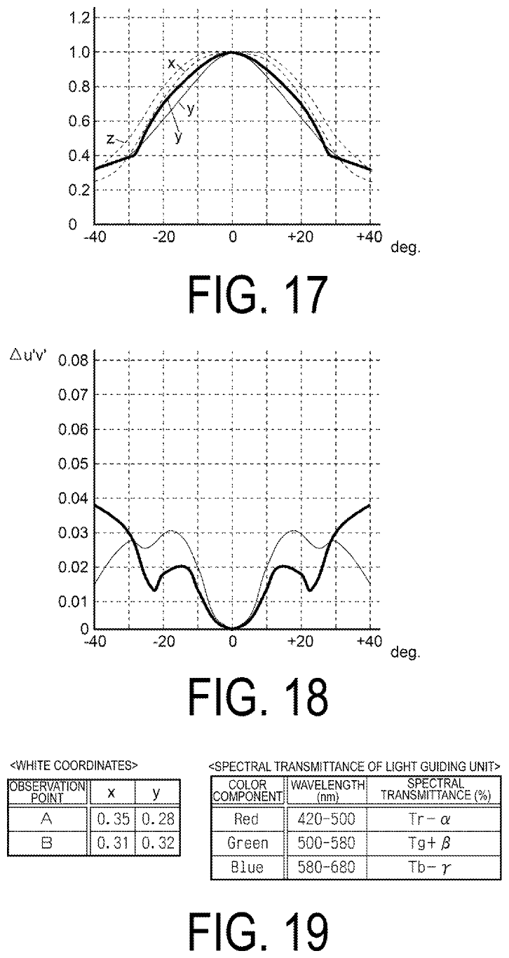

Next, a case in which the light distribution characteristics of the sub-pixel 11G are poor in the display panel 10 will be described. In this case, as described under Countermeasure 2 in FIG. 16, adjustment is performed such that the light emission intensity in the sub-pixel 11G becomes weaker and/or the light emission intensities in the sub-pixels 11G and 11B become stronger. With such an adjustment, the light distribution characteristics of the y component of the white light is improved from the thin solid line to the thick solid line as indicated in FIG. 17, and the color change of the white light is suppressed from the thin solid line to the thick solid line as indicated in FIG. 18.

However, with such an adjustment, as shown in the left table of FIG. 19 or in FIG. 20, the coordinates (x, y) of the white point at the observation point A become (0.35, 0.28) and are shifted from the original white coordinates (0.31, 0.32). As a result, the white coordinates at the observation point A become biased toward magenta. In other words, display unevenness of the display panel 10 is magenta.

Thus, the spectral transmittance of the light guiding unit 20 is adjusted such that the wavelength components of B and R become weaker and/or the wavelength component of G becomes stronger. Specifically, as shown in the right table of FIG. 19, the spectral transmittance of the light guiding unit 20 is adjusted such that the transmittance of the red component is weakened by α from Tr to (Tr−α), the transmittance of the green component is strengthened by β from Tg to (Tg+β), and the transmittance of the blue component is weakened by γ from Tb to (Tb−γ). With this adjustment, the white coordinates at the observation point B are returned to the white color from the state of being biased toward magenta (see FIG. 20), and thus, the display unevenness of being biased toward magenta in the display panel 10 is suppressed.

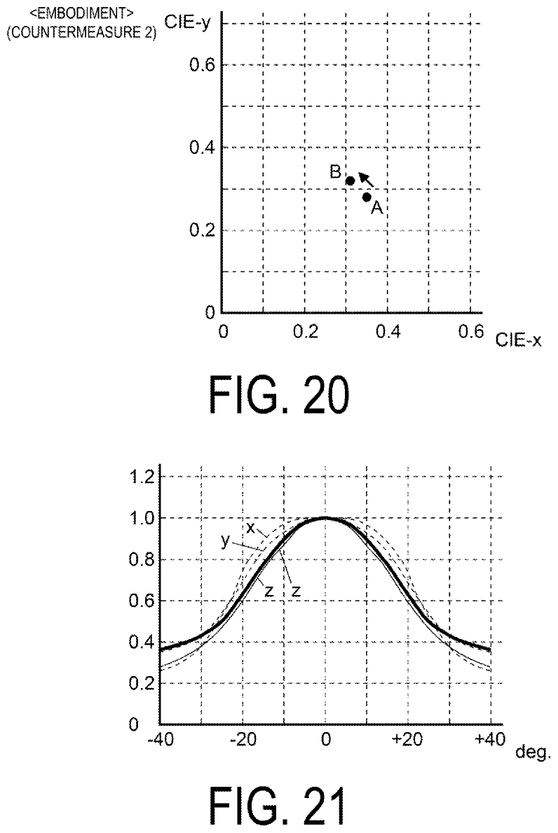

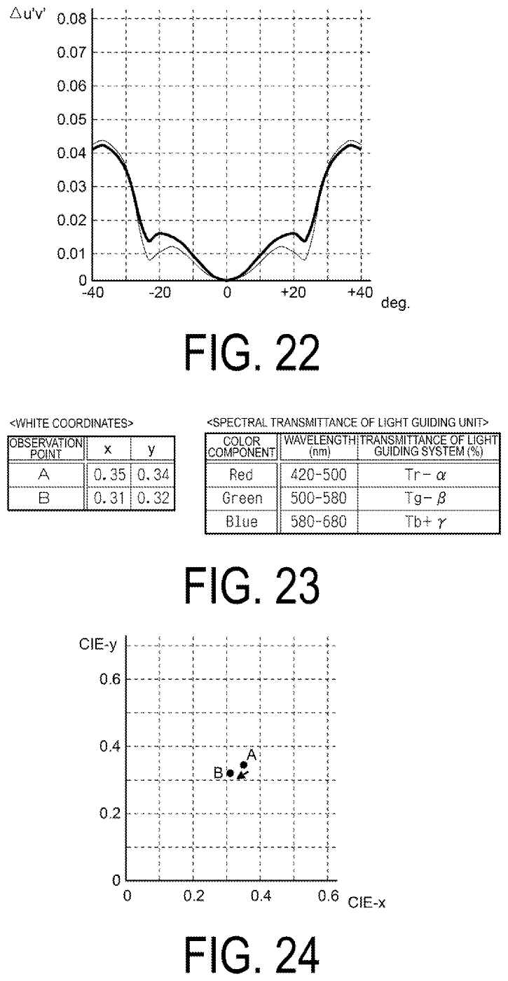

Next, a case in which the light distribution characteristics of the sub-pixel 11B are poor in the display panel 10 will be described. In this case, as described under Countermeasure 3 in FIG. 16, adjustment is performed such that the light emission intensity in the sub-pixel 11B becomes weaker and/or the light emission intensities in the sub-pixels 11G and 11B become stronger. With such an adjustment, the light distribution characteristics of the z component of the white light are improved from the thin solid line to the thick solid line as indicated in FIG. 21, and the color change of the white light is suppressed from the thin solid line the thick solid line as indicated in FIG. 22.

However, with such an adjustment, as shown in the left table of FIG. 23 or in FIG. 24, the coordinates (x, y) of the white point at the observation point A become (0.35, 0.34) and are shifted from the original white coordinates (0.31, 0.32). As a result, the white coordinates at the observation point A become biased toward yellow. In other words, the display unevenness of the display panel 10 is yellow.

Thus, the spectral transmittance of the light guiding unit 20 is adjusted such that the wavelength components of R and G become weaker and/or the wavelength component of R becomes stronger. Specifically, as shown in the right table of FIG. 23, the spectral transmittance of the light guiding unit 20 is adjusted such that the transmittance of the red component is weakened by α from Tr to (Tr−α), the transmittance of the green component is weakened by β from Tg to (Tg−β), and the transmittance of the blue component is strengthened by γ from Tb to (Tb+γ). With this adjustment, the white coordinates at the observation point B are returned to the white color from the state of being biased toward yellow (see FIG. 24), and thus, the display unevenness of being biased toward yellow in the display panel 10 is suppressed.

Next, an electronic apparatus to which the display device 10 according to the embodiment is applied will be described.

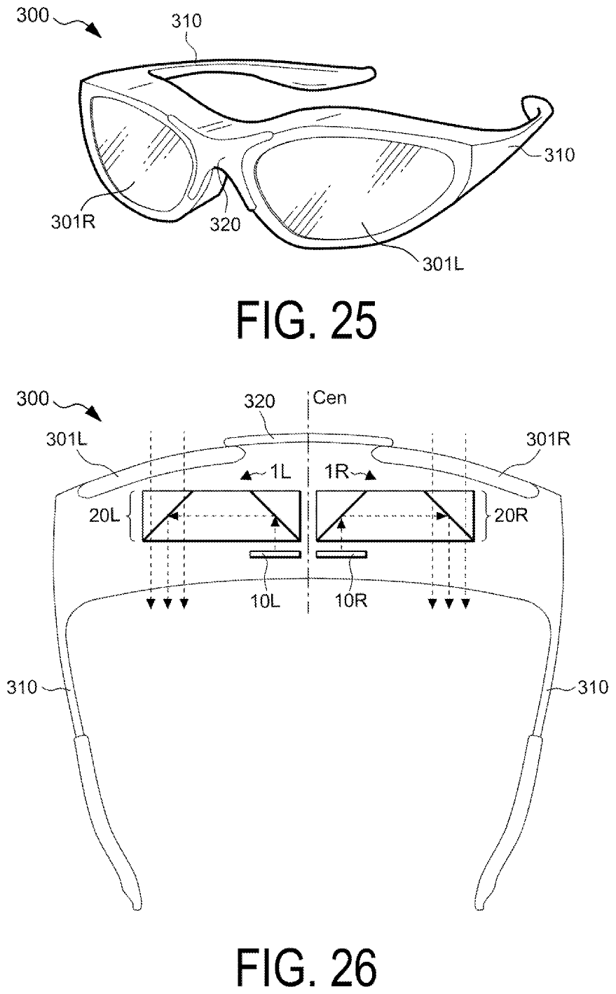

FIG. 25 is a diagram illustrating a headset 300 of a head mounted display system to which the display device 10 is applied, and FIG. 26 is a diagram illustrating an optical configuration of the headset 300.

The headset 300 externally includes temples 310, a bridge 320, and lenses 301L and 301R as in the case of general glasses. Further, as illustrated in FIG. 26, in the headset 300, a display device 1L for a left eye and a display device 1R for a right eye are provided in the vicinity of the bridge 320 and on the back side (lower side in the drawing) of the lenses 301L and 301R.

The display device 1L for the left eye includes a display panel 10L and a light guiding unit 20L. The display panel 10L is disposed so as to emit image light in the upward direction in FIG. 26. As a result, the image light from the display panel 10L is reflected twice by the light guiding unit 20L and is emitted downward in the drawing. Note that the light guiding unit 20L allows the user to visually recognize the outside scene in the see-through state, as described above with reference to FIG. 1.

The display device 1R for the right eye includes a display panel 10R and a light guiding unit 20R, and is disposed symmetrically to the display device 1L with respect to a center Cen of the headset 300.

In this configuration, the user wearing the headset 300 can observe the image light from each of the display panels 10L and 10R in the see-through state in which the image light from each of the display panels 10L and 10R is superimposed on the outside scene. Further, in the head-mounted display 300, of images for both eyes with parallax, image light for the left eye is emitted by the display panel 10L, and image light for the right eye is emitted by the display panel 10R. As a result, it is possible to cause the user to perceive the emitted image light as image light having depth or a three-dimensional effect.

Note that, in addition to the headset of the head-mounted display, examples of the electric apparatus to which the display device 1 can be applied include an electronic viewing finder in a video camera, a lens-exchangeable digital camera, or the like, a mobile information terminal, a wristwatch display unit, and a light valve for a projection-type projector.

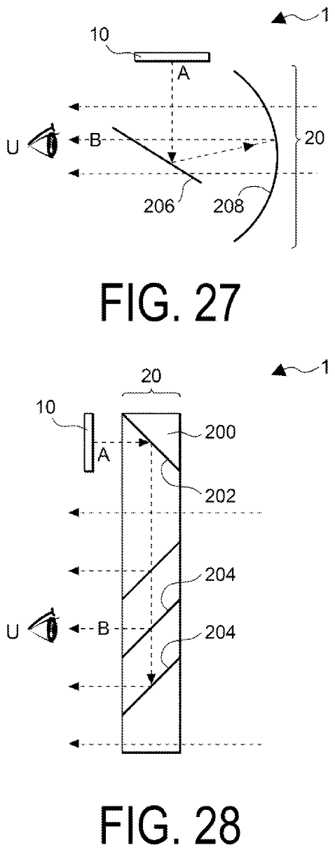

The display device 1 is not limited to the configuration illustrated in FIG. 1, and may have a configuration illustrated in FIG. 27 or FIG. 28, for example.

FIG. 27 is a diagram illustrating an optical path of the display device 1 according to a first modified example of the embodiment. The display device 1 according to the first modified example is an example in which the light guiding unit 20 includes a half mirror 206 and a concave mirror 208.

More specifically, in FIG. 27, the image light emitted from the display panel 10 is reflected by the half mirror 206 and is incident on the concave mirror 208. Then, the image light reflected by the concave mirror 208 is transmitted through the half mirror 206. Further, the outside light is transmitted through the concave mirror 208 and the half mirror 206.

FIG. 28 is a diagram illustrating an optical path of the display device 1 according to a second modified example of the embodiment. The display device 1 according to the second modified example is an example in which the light guiding unit 20 includes the mirror 202 and a plurality of the half mirrors 204. The optical path from the display panel 10 to the user U through the light guiding unit 20 is the same as the configuration illustrated in FIG. 1, except that the plurality of half mirrors 204 are provided.

For example, the following aspects of the disclosure are understood from the embodiment illustrated above.

A display device according to an aspect (first aspect) includes a display panel configured to emit color image light, and a light guiding unit configured to guide the color image light. When the color image light emitted from the display panel is white image light, color coordinates of the white image light are different from color coordinates of image light obtained as a result of the white image light being guided by the light guiding unit. According to the first aspect, it is possible to suppress the display color unevenness while maintaining the white color perceived by the user.

In a display device according to a specific aspect (second aspect) of the first aspect, a color difference between the white color of the color image light emitted from the display panel and a color of the image light guided by the light guiding unit is greater than 0.02. When the color difference between two colors is 0.02 or less, the difference between the two colors cannot be perceived by a human and thus can be ignored.

In a display device according to a specific aspect (third aspect) of the first aspect, the display panel emits the color image light by additive color mixing of a first color, a second color, and a third color, and in a case in which display unevenness in the display panel is caused by the first color, in the light guiding unit, a spectral transmittance of a complementary color of the first color is smaller than a spectral transmittance of the first color.

In the display device according to the third aspect, the case in which the display unevenness in the display panel is caused by the first color is, as in a display device according to a fourth aspect, a case in which, a change in radiance of the first color is greater than a change in radiance of the second color and a change in radiance of the third color, that is, a case in which the radiance of the first color is adjusted to be relatively weaker than the radiance of the second color and the radiance of the third color.

For example, an example of the first color is red, an example of the second color is green, and an example of the third color is blue.

An electronic apparatus according to a fifth aspect includes the display device according to any one of the first to fourth aspects. According to the fifth aspect, an electronic apparatus is provided that suppresses the display color unevenness while maintaining the white color perceived by the user.

What is claimed is:

1. A display device comprising:
a display panel configured to emit color image light; and
a light guiding unit configured to guide the color image light, wherein
when the color image light emitted from the display panel is white image light, color coordinates of the white image light are different from color coordinates of image light obtained as a result of the white image light being guided by the light guiding unit.

2. The display device according to claim 1, wherein
a color difference between the white color of the color image light emitted from the display panel and a color of the image light guided by the light guiding unit is greater than 0.02.

3. The display device according to claim 1, wherein
the display panel emits the color image light by additive color mixing of a first color, a second color, and a third color, and
in a case in which display unevenness in the display panel is caused by the first color, in the light guiding unit, a spectral transmittance of a complementary color of the first color is smaller than a spectral transmittance of the first color.

4. The display device according to claim 3, wherein
the case in which the display unevenness in the display panel is caused by the first color is a case in which, when an observation angle changes, a change in radiance of the first color is greater than a change in radiance of the second color and a change in radiance of the third color.

5. An electronic apparatus comprising
the display device according to claim 1.
